(19) United States
(12) Patent Application Publication
(10) Pub. No.: US 2021/0387256 A1
(43) Pub. Date: Dec. 16, 2021

(54) METHOD AND EQUIPMENT FOR REMOVING ORGANIC BINDERS FROM GREEN BODIES

(71) Applicants: ROMAIN LOUIS BILLIET, PENANG (MY); HANH THI NGUYEN, PENANG (MY)

(72) Inventors: ROMAIN LOUIS BILLIET, PENANG (MY); HANH THI NGUYEN, PENANG (MY)

(21) Appl. No.: 16/900,881

(22) Filed: Jun. 13, 2020

(51) Int. Cl. B22F 3/10; B08B 7/04; B08B 3/08; C04B 35/638

(52) U.S. Cl. CPC B22F 3/1025; B08B 7/04; B22F 2301/35; C04B 35/638; B08B 3/08

(57) ABSTRACT

Green bodies are safely, economically and efficiently debound in a dual quartz reactor by subjecting them to a steady laminar upward flow of freshly distilled solvent so that the concentration difference of soluble binder at the green body/solvent interface is at all times maximized for optimum binder extraction as per Fick's laws of diffusion. Binder extraction rate is monitored by inline spectrophotometry of the reactor overflow. Following solvent extraction, the residual insoluble binder is thermally extracted without the need to transfer the green bodies to a different vessel.

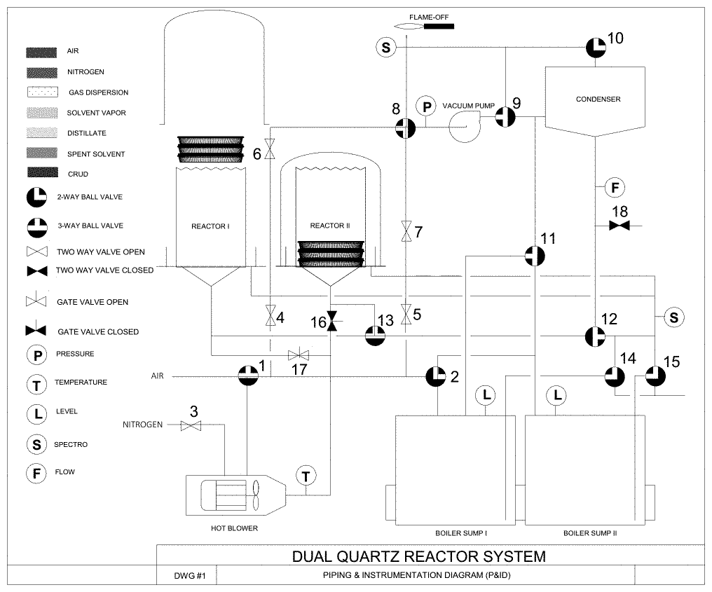

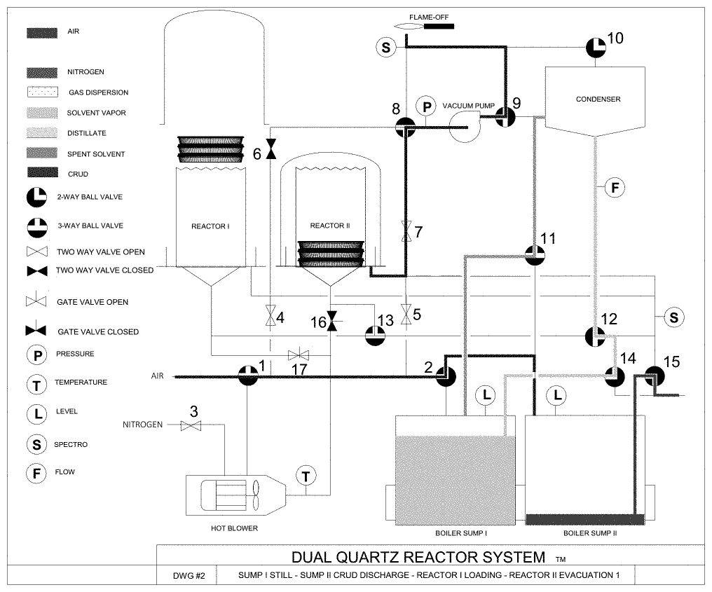

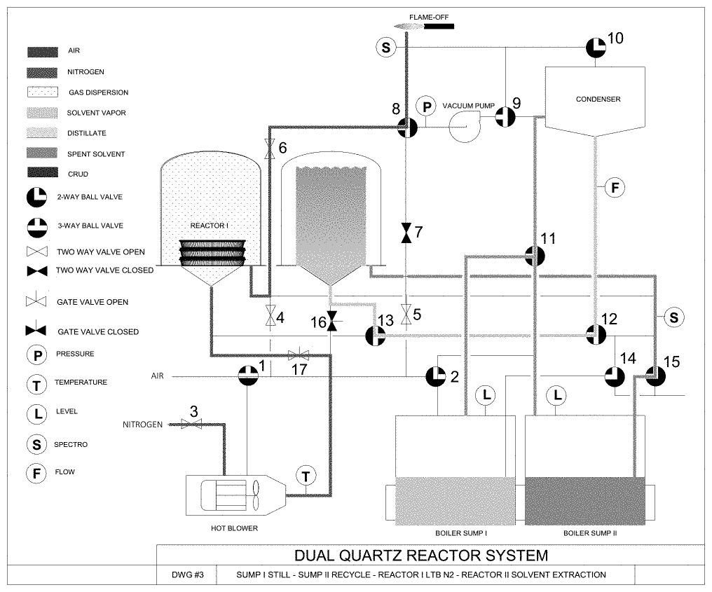

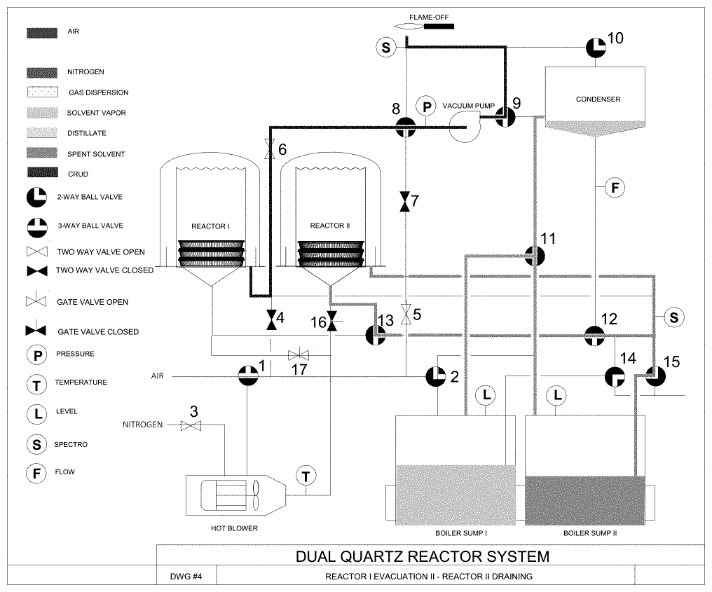

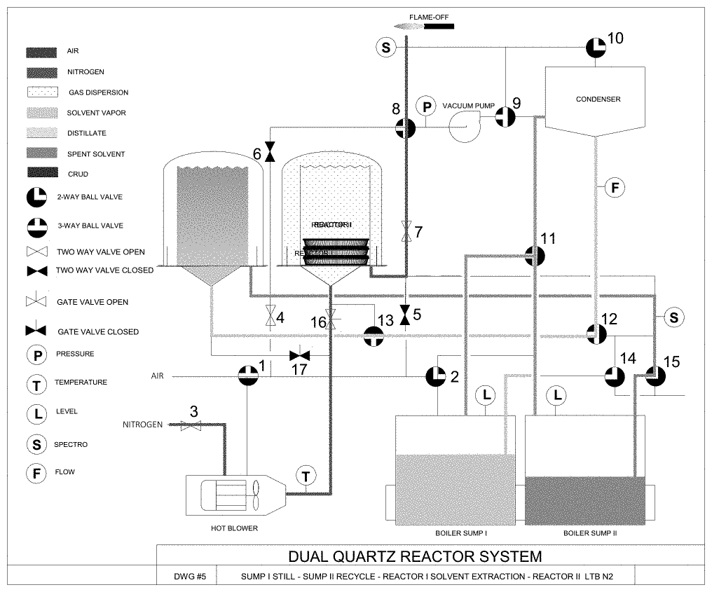

### CROSS-REFERENCE TO RELATED APPLICATIONS

This application claims priority to U.S. Provisional Patent Application Ser. No. 62/985,330 filed on Mar. 5, 2020.

### REFERENCES CITED

### U.S. Patent Documents

| | | | |
|---|---|---|---|
| 5,028,367 | 7/1991 | Wei et al. | 264/63 |
| 5,366,679 | 11/1994 | Streicher | 264/125 |
| 5,531,958 | 7/1996 | Krueger | 419/44 |
| 5,627,258 | 5/1997 | Takayama et al. | 528/338 |
| 10,464,131 | 11/2019 | Mark | B22F 3/008 |
| 2002/0007000 | 1/2002 | Yokoyama et al. | 524/494 |
| 2004/0138049 | 7/2004 | Yasrebi et al. | 501/127 |
| 2008/0116621 | 5/2008 | Brennan et al. | 264/606 |
| 2018/0154438 | 6/2018 | Mark | B22F 3/008 |
| 2018/0154439 | 6/2018 | Mark | B22F 3/1021 |
| 2018/0257138 | 9/2018 | Mark | B22F 3/008 |
| 2019/0210106 | 7/2019 | Gibson et al. | B22F 3/1025 |
| 2019/0240734 | 8/2019 | Tobia | B22F 3/24 |
| 2020/0001363 | 1/2020 | Gibson et al. | B22F 3/1025 |
| 2020/0061705 | 2/2020 | Gibson et al. | B22F 3/1025 |
| 2020/0061706 | 2/2020 | Gibson et al. | B22F 3/1025 |

### Foreign Patent Documents

### OTHER PUBLICATIONS

### Non-Patent Literature

Quackenbush, C. L., French, K., Neil, J. T.: “Fabrication of Sinterable Silicon Nitride by Injection Molding”—Ceram. Eng. & Sci. Proc., Vol. 3, 1982, pp. 20-24—Online ISBN: 9780470318140—Print ISBN; 978040373934
Fan, J. L., Li, Z. X., Huang, B. Y., Cheng, H. C., Liu, T.: “Debinding process and carbon content control of hardmetal components by Powder Injection Molding”—Powder Injection Moulding International, Vol. 1, No. 2, June 2007, pp. 57-62
Billiet, R.: “Plastic Metals: The Injection Molded P/M Materials Are Here”-Proceedings P/M 82, Associazione Italiana di Metallurgia, Milano, Italy, 1982, pp. 603-610
Billiet, R.: “Plastic Metals: From Fiction to Reality with Injection Molded P/M Materials”—Progress in Powder Metallurgy, 1982, vol. 38, pp. 45-52
Billiet, R.: “Net-Shape Full Density P/M Parts by Injection Molding”—International Journal of Powder Metallurgy and Powder Technology, 1985, vol. 21, pp. 119-129
Kim, Y-H., Lee, Y-W., Park, J-K., Lee, C-H., Lim, J. S.: “Supercritical Carbon Dioxide Debinding in Metal Injection Molding (MIM) Process”—Korean J. Chem. Eng. 19(6), 986-991 (2002)

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND

### Field of the Invention

The present invention relates to methods and equipment for removing organic binders from green bodies.

### Description of Prior Art

Green bodies can be defined as three-dimensional shapes produced from intimate mixtures of a discrete phase comprising particulate materials which, upon sintering, are to yield the desired material composition of the end product, and a continuous phase consisting of a mixture of organic materials the sole purpose of which is to confer the transient property of thermoplasticity to the green mixture so that it can be shaped under the effect of heat and pressure.

The prior art uses various methods to form green bodies, the main ones being:

1. Injection Molding
Metal Injection Molding (MIM) and Ceramic (including Cemented Carbide) Injection Molding, (CIM and CCIM), all use the techniques and equipment of the plastics injection molding industry,

2. Casting
When the green material is formulated to have the right viscosity, it can be cast into a mold.

3. Machining, Also Called Green Machining
In this technique, sometimes used for rapid prototyping. a green part is conventionally machined from a blank of green material.

4. Additive Manufacturing (AM) Also Called 3D-Printing
This is a relatively recent technology in which a green part is built up layer by layer.

It is highly desirable to remove any organic binders from green bodies prior to sintering to avoid carbon inclusion in the end products and contamination of the sintering equipment by condensed binder degradation products as this will shorten the equipment's useful economic lifetime and prevent the attainment of high vacuum levels.

The prior art uses various methods to extract organic binders from green bodies depending on the latter's chemical composition. The most common of these are briefly reviewed.

### (i) Water-Soluble Binders

Water-soluble binders carry the inherent risk of oxidation of some materials, e.g. titanium. By way of example of this technique, Takayama et al. U.S. Pat. No. 5,627,258 use a binder comprising 40-70% of a water-soluble amide and/or water-soluble amine and 25-60% of a polyamide resin. Following elution of the amide/amine material by a water-based solvent, the polyamide resin is removed by heating.

### (ii) Wicking

Wicking is a debinding technique in which the green bodies are placed on or embedded in a porous support or medium, e.g. aluminum oxide powder. Upon heating, the soluble binder component liquefies and is drawn into the porous support/medium by capillary action.
   (iii) Catalytic Debinding
Initially developed by BASF, Germany, under the trade name Catamold™, these feedstocks are debound in nitric acid vapor, a bio-hazardous and environmentally unfriendly medium generating formaldehyde as a by-product.

### (iv) Supercritical Debinding

Ki, Y-C. et al. describe a debinding process in which, supercritical CO₂ in conjunction with co-solvents, e.g. n-hexane, methanol, is pumped into the extraction vessel containing the green bodies at 25 MPa and 348° K (74.85° C.). The authors claim short debinding times of 2 hours, versus 15 hours for debinding by wicking at 723° K (449.85° C.).
   (v) Pyrolysis including Vacuum Distillation
The green parts are slowly heated in an inert atmosphere or in vacuum.

### (vi) Solvent Debinding, Also Called Solvent Extraction (SX)

Krueger, U.S. Pat. No. 5,531,958 claims: “Solvent debinding is an alternative process that improves the debinding rate versus pyrolysis. The parts are immersed in liquid or vapor of an extracting solvent. The solvent accelerates the removal of binder from the parts and helps open-up porosity in the part. Solvent debinding still requires that the residual binder and solvent be removed from the part thermally. The advantage of solvent debinding is that it increases the debinding rate of the parts over pyrolysis. However, the disadvantages of the process include long extraction times.

Wei in U.S. Pat. No. 5,028,367 cites: “[ . . . ] it requires several days to completely remove the binder from the compact.”

C. L. Quackenbush (cf. Non-Patent Literature) reports binder extraction times of 150 hours (6.25 days) for a 3.5 mm thick slab of green silicon nitride.

Another disadvantage of Solvent Extraction (SX) is the recycling or disposal of spent solvent. An environmental concern is that many of today's solvents contain chlorine and are being phased out or banned following the 1978 Montreal Protocol because of concerns over the ozone layer.

Yet another problem with Solvent Extraction (SX) is to determine the time for completion of the debinding step. As it is based on part geometry (part wall thickness or cross-section), it is usually determined empirically or based on engineering studies of specific parts. Part wall thickness can be obtained from CAD drawings. Verification of extraction efficiency implies interrupting the extraction process, drying the parts to remove any solvent locked up in the porosity, and checking the weight loss. If the weight loss is deemed insufficient, the parts must be returned to the solvent bath for additional processing, clearly a costly and counterproductive method. Also, it should be noted that binder formulations are not always constant and may have to be altered to accommodate molding rheology.

Consequently, there is a need for an improved technique that obviates the problems of the prior art.

### BRIEF SUMMARY OF THE INVENTION

According to the present invention, there is provided a method and equipment to safely, efficiently and economically remove organic binders from green bodies.

The principle of the instant invention is based on maximizing the solvent diffusion coefficient throughout the debinding process. This is achieved in practice through controlled laminar inundation of the workload. Contrary to what is happening in the prior art where the green parts are invariably immersed in a solvent bath, in the instant invention, the green parts are flooded or inundated in a Reactor Tank by a steady laminar upward stream of freshly condensed solvent while the binder extraction rate is monitored by spectrophotometry of the spent solvent in the Reactor Tank overflow.

The process will be explained in detail below.

### Objects and Advantages

It is an object of the present invention to provide an efficient, economical and safe way to remove organic binders from green bodies.

The main advantages of the binder removal system used in the instant invention are:
single rather than separate operations. It is not necessary to transfer the green bodies from one vessel to another following the solvent debinding step,
no need for solvent pumps, prone to leakage,
the use of non-flammable, zero ODP (Ozone Depleting Potential) solvent,
process efficiency. No residual organics are left behind,
solvent recovery is 98% or better.
fastest binder removal possible based on optimized diffusion conditions of Fick's Laws of Diffusion,
environmentally safe. By-products are carbon dioxide and water vapor which can be freely discharged into the atmosphere.
economical. The system can be built in-house by any technician capable of brazing copper tubing.

easy and efficient process control. The end point of the Solvent Extraction (SX) step is reached when the solvent coining out of the System (the spent solvent) is as clean the freshly condensed solvent going in. This is verified by inline spectrophotometry or other suitable trace organic materials analysis. No need to interrupt the process to check the weight loss of the parts,
visual monitoring of the processes through the transparent quartz hardware,
automation can be achieved by using pneumatically or electrically actuated valves.

### BRIEF DESCRIPTION OF THE SEVERAL VIEWS OF THE DRAWINGS

DWG #1 is a Piping & Instrumentation Diagram (P&ID) showing the main components of the System used in the application of the instant invention, namely:
two stainless steel drums (Boiler Sumps I and II) each fitted with an electric heating jacket. Boiler Sump I is for clean, i.e. fresh or distilled solvent (distillate) while Boiler Sump II is for spent solvent, i.e. solvent containing binder decomposition products.
two Quartz Reactor assemblies, each consisting of a 0220 mm×400 mm (15 lit) Quartz Reactor Tank and a matching 0300 mm×517 mm Quartz Bell Jar,
one Hot Blower mounted in an enclosure equipped to receive an injection of air and/or nitrogen gas,
one Solvent Condenser mounted at a level above the Reactor tanks,
one Vacuum Pump,
a plurality of one-, two- and three-way valves
a level indicator on each of the Boiler Sumps,
a thermocouple on the piping leading from the Hot Blower to the Reactor tanks,
a Spectrophotometer on the piping conveying condensate or spent solvent
a Flame-Off burner on the exhaust to atmosphere

DWG #2 shows the System in following condition:
Boiler Sump I is in Still Recycling Mode, i.e. it is full of fresh or distilled solvent. The sump is heated causing solvent to evaporate and the vapor to rise to the Condenser where it is condensed and returned to the sump by gravity.
Boiler Sump II is in Crud Discharge Mode. Crud is the term used to describe solvent that has reached its maximum concentration (saturation) of solute, at which time it is no longer able to perform and must be sent to an outside solvent recycling facility. Crud transfer is done by injecting compressed air into Boiler Sump II and collecting the Crud outside.
Reactor I is in Loading Mode
Reactor II is in Evacuation Mode using the Vacuum Pump which discharges to atmosphere while the Flame-Off burner burns off any trace amounts of residual organic.

DWG #3 shows the System in following condition:
Boiler Sump I is in Normal Operation Mode, i.e. the solvent vapor rises to the Condenser from where the condensate is directed to Reactor Tank II.
Boiler Sump II is in Recycle Mode, receiving spent solvent (overflow) from Reactor II while solvent vapor generated in Boiler Sump II is condensed in the Condenser.
Reactor I is in Low Temperature Burnout (LTB) Mode, receiving hot nitrogen gas from the Hot Blower and discharging it to atmosphere via the Flame-Off burner.
Reactor II is in Solvent Extraction (SX) Mode.

DWG #4 shows the System in following condition:
Boiler Sump I is in Normal Still Recycling Mode, i.e. solvent vapor rises to the Condenser where the resulting condensate is kept until Reactor II is in Solvent Extraction (SX) mode.
Boiler Sump II receives solvent drained from Reactor II. Solvent vapor generated in Boiler Sump II is directed to the Condenser.
Reactor I is in Evacuation Mode, with the Vacuum Pump discharging to atmosphere.
Reactor II is in Drainage Mode.

DWG #5 shows the System in following condition:
Boiler Sump I is in Normal Operation Mode, i.e. solvent vapor rises to the Condenser where it is condensed and directed to Reactor I.
Boiler Sump II receives the solvent drained from Reactor I. Solvent vapor generated in Boiler Sump II is condensed in the Condenser.
Reactor I is in Solvent Extraction (SX) Mode.
Reactor II is in Low Temperature Burnout (LTB) Mode, receiving hot nitrogen gas from the Hot Blower and exhausting it to atmosphere via the Flame-Off burner.

### Installation and Operation of the System

### (i) Installing the Quartz Reactor Assemblies

The Quartz Reactor Assemblies must be mounted near the Boiler Sumps and at a level such that liquid solvent can flow back from the Quartz Reactors to the Boiler Sumps by gravity.

### (ii) Installing the Condenser(s)

The Condenser(s) must be mounted at a height such that their bottom outlet is at a level above the overflow weir of the Quartz Reactor Tanks to allow gravity flow of distillate from the Condenser(s) to the Reactor Tanks.

(iii) Loading the Green Parts

The green parts are loaded in stackable carrier baskets or on trays. It is important to allow for the maximum of green part surface to be exposed to the solvent flow. The ideal carriers are stainless steel test sieves used for particle size analysis (PSA). The sieve diameter should be 8″ (203 mm) to fit perfectly into the Quartz Reactor Tanks. The sieves should be of welded construction to withstand exposure to high temperature (max. 600° C.) during LTB.

### (iv) Fitting and Sealing the Bell Jar

After loading the green parts into the Quartz Reactor Tank, the Bell Jar is placed over it. A temperature and solvent resistant gasket is used between the Tank and the Bell Jar. The Bell Jar is clamped onto the Reactor Tank.

### (v) Solvent Extraction (SX) Step

The SX operational procedure has been explained in foregoing description.

### (vi) Reactor Drainage

Upon completion of the SX step, the Reactor is drained to Boiler Sump II.

(vii) Reactor Tank Evacuation

After drainage, the Reactor Tank is evacuated to a moderate vacuum (>25″ Hg) to extract any remaining solvent trapped inside the porous green parts. This step is important as the amount of residual solvent can be as high as 50% of part volume. The vacuum pump discharges to the Condensers to recuperate the trapped solvent which flows back to Boiler Sump I.

(viii) Low Temperature Burnout (LTB) Step

Following evacuation of the Reactor Tank and drying of the green parts, the LTB step can be initiated, using hot air or nitrogen gas or a combination of both.

### DETAILED DESCRIPTION

In what follows, the invention will be described in more detail by way of a non-binding practical example. The feedstock formulation (based on 100 g. feedstock) used in the example is:

| | weight | density | volume |
|---|---|---|---|
| | % | g · cm⁻³ | cm³ |
| Stainless steel powder | 93.020 | 7.89 | 11.790 |
| HDPE (total Organic Insoluble (OS)) | 3.600 | 0.954 | 3.774 |
| Stearin | 3.281 | 0.840 | 3.906 |
| Stearic Acid | 0.099 | 0.940 | 0.104 |
| Total Organic Soluble (OS) | 3.380 | 0.843 | 4.010 |
| Total Organic (Binder) | 6.980 | 0.897 | 7.784 |
| Total Feedstock | 100 | 5.109 | 19.574 |

Binder extraction by Solvent Extraction (SX) relies on three simultaneous mechanisms, i.e.:

(i) Dissolution, i.e. the solubility of the wax component in the chosen solvent,
(ii) Diffusion, as a result of the random thermal motion of solute wax molecules,
(iii) Convection, i.e. the transport of solute wax molecules by solvent flow.

The effects of each of these mechanisms on the instant invention will now be reviewed in detail.

### 1. Dissolution

Dissolution depends on the solvent's Hildebrand solubility parameter as well as on environmental and economic considerations, e.g. temperature, flammability, pressure, ozone depletion potential (ODP) and cost.

Until the mid-1980s, CFCs, e.g. Freon 112, were in widespread use but in 1987, the Montreal Protocol banned or severely restricted their use. Consequently, chemical companies like DuPont, Wilmington, Del. and others, developed zero ODP solvents. DuPont's Vertrel MCA™, a non-flammable, proprietary azeotrope of 2,3-dihydrodecafluoropentane and trans-1,2-dichloroethylene (1,2 dichloroethene) commonly used as a solvent for waxes, resins, polymers, fats and lacquers has a Hildebrand solubility parameter of 15.2 MPa^{1/2} that is higher than that of the commonly used hexane (14.1 MPa^{1/2}. This solvent has been used for the design of the equipment of the instant invention.

### 2. Diffusion

Fick's First Law of Diffusion states that the diffusive flux goes from regions of high concentration to regions of low concentration with a magnitude proportional to the concentration gradient.

In one spatial dimension:

J=−D*(δΦ/δx)

where

J is the diffusive flux in dimensions [MIL⁻²T⁻¹], (e.g. mol/m²s)

D is the diffusion coefficient in dimensions [L²T⁻¹], (e.g. m²/s)

Φ is the concentration in dimensions [ML⁻³], (e.g. mol/m³)

x is the position in dimensions [L], (e.g. in)

In a paper presented by Fan J. L. et al. of the State Key Laboratory for PM, Central South University, Hunan, Changsha, PRC (cf. Non-Patent Literature) the researchers state:

“At the start of debinding, the concentration difference between the specimens and the solvent is large, it is easy for the soluble component to diffuse and dissolve into the solvent from the specimens, so the debinding rate is high. With increasing time, the concentration difference between the specimens and solvent decreases, the solvent debinding enters into the dissolution control period and the concentration difference becomes the main factor to affect the debinding rate. With the decrease of concentration difference, the diffusion and dissolution rate decrease in spite of increase in the total binder weight loss.”

This research merely confirms Fick's Law of Diffusion and that the binder extraction rate will be maximized if and only if the concentration difference is maintained at a maximum which is the fundamental principle on which the instant invention is based.

### 3. Convection

Convective transport occurs when Organic Soluble (OS), i.e. solvated wax molecules are carried away by the solvent flow.

If θ is the volume concentration of OS molecules in the feedstock (as per feedstock formulation), we have,

dn/dx=dn/dy=dn/dz=θ

or, in one spatial dimension,

dy/dt=(1/θ)*dn/dt

where
dn/dt is the volume fraction of OS molecules being solvated per unit time, i.e. the rate at which OS molecules are being solvated and
dy/dt is the upward velocity.

The number of OS molecules being solvated is equal to the number of available OS molecule sites exposed to the solvent. This number is θ, the volume concentration of OS molecules at the green body/solvent interface.

The volume fraction of soluble matter in the feedstock (θ) is:

4.010 cm³/19.574 cm³=2.049*10⁻¹

The soluble matter in the feedstock is stearin with properties:

molar mass, in: 891.48 g·mol⁻¹

molar volume: 891.48 g·mol⁻¹/0.84 g·cm⁻³=1,061.29 cm³·mol⁻¹

molecular volume: 1,061.29 cm³·mol⁻¹/6.022*10²³ mol⁻¹ or 1.762*10⁻²¹ cm³

molecular diameter, a (based on the hard sphere model):

a=6*1.762*10⁻²¹ cm³/π)^{1/3}=1.5*10⁻⁷ cm

The Diffusion Coefficient is given by:

D=SQRT(k³/π³m)*(T^{3/2}/Pa²)

where k is Boltzmann's constant
T is the absolute temperature (20° C.+273.15)
P is the pressure (1 atm)

yielding D=2.15*10⁻¹⁵ cm² s⁻¹

Consequently, a 1.5*0⁻⁷ cm thick film of solvent covering a 1 cm×1 cm surface of green body (i.e. 1.5*10⁻⁷ cm³ of solvent) will generate 2.049*10⁻¹×1.5*10⁻⁷ cm³=3.07*10⁻⁸ cm³ of solvated matter per cm² of green body surface.

This solvated matter must be carried away by the solvent stream as fast as practical in order to maintain the maximum concentration gradient in the spent solvent and thereby the highest dissolution rate.

The solvent upward velocity or upflow (mm/s) is the variable controlling the rate at which solute molecules are being carried away. Empirically it has been determined that an upward velocity of about 10 mm/min (1.67*10⁻¹ mm/s) is adequate.

In the example used to illustrate the invention, the green parts are processed in a Ø220 mm×400 mm (15 lit) Quartz Reactor Tank. Thus at an upward velocity of 10 mm/min, it will take 40 min (to fill an empty Reactor Tank, substantially less for a loaded one. This corresponds to a solvent flowrate of 15 lit/0.66 h or 22.52 lph which defines the necessary condensation capacity of the solvent condenser(s).

### CONCLUSION, RAMIFICATIONS AND SCOPE

In conclusion, the major advantage of this invention resides in the ability to safely, economically and efficiently remove organic binders from green bodies.

Although the invention has been described with respect to specific preferred embodiments thereof, many variations and modifications will immediately become apparent to those skilled in the art. It is therefore the intention that the claims be interpreted as broadly as possible in view of the prior art to include all such variations and modifications

We claim as our invention:

1. A method and equipment for removing organic binders from green bodies, comprising at least:
a. two steel drums, herein called Boiler Sumps, each fitted with a heating jacket and equipped with level indicators,
b. two quartz tank and bell jar assemblies, herein called Reactors,
c. one solvent condenser,
d. one vacuum pump,
e. one blower capable of delivering hot air or nitrogen gas at up to 600° C.,
f. one flame-off burner mounted on the installation's exhaust,
g. one spectrophotometer or other suitable trace organics analyzer,
h. a plurality of one-, two- and three-way valves.

2. The installation as set forth in claim 1 wherein solvent in the Boiler Sumps is evaporated and the resulting vapor condensed in the condenser.

3. The installation as set forth in claim 2 wherein said condensed solvent is directed either to the Boiler Sumps or to the bottom of the Reactors by gravity flow.

4. The installation as set forth in claim 1 wherein the Reactors are loaded with green bodies.

5. The installation as set forth in claim 4 wherein said green bodies are inundated by an upward stream of condensed solvent.

6. The installation as set forth in claim 5 wherein said solvent overflowing the Reactor is directed to the Boiler Sump by gravity flow.

7. The installation as set forth in claim 6 wherein said solvent overflowing the Reactor is analyzed by spectrophotometry or other suitable trace organics analytical technique.

8. The installation as set forth in claim 7 wherein, following solvent extraction, said green bodies are vacuum dried and exposed to an upward stream of hot air, nitrogen, or a mixture of both.

9. The installation as set forth in claim 8 wherein said green bodies are thermally debound in said Reactor without having to be transferred to a different vessel.
